(19) United States
(12) Patent Application Publication
(10) Pub. No.: US 2016/0265991 A1
(43) Pub. Date: Sep. 15, 2016

(54) Measurement Systems

(71) Applicant: Ashton Instruments, Inc., Cambridge, MA (US)

(72) Inventors: William Robert Dixon, Cambridge, MA (US); James Crandall Schulmeister, Cambridge, MA (US)

(73) Assignee: ASHTON INSTRUMENTS, INC., Cambrifge, MA (US)

(21) Appl. No.: 14/641,651

(22) Filed: Mar. 9, 2015

(51) Int. Cl. G01L 3/10; G01L 25/00

(52) U.S. Cl. CPC G01L 3/10; G01L 25/003

(57) ABSTRACT

In general, in one aspect, a measurement system has measurement instrument having a first and second component. The first component is mechanically coupled to a first point on a shaft. The second component is mechanically coupled to a second point on the shaft. The measurement instrument is configured to generate an electrical displacement signal indicative of a displacement between the first and second components. A processor is in data communication with the measurement instrument, and the processor configured to: receive the displacement signal from the measurement instrument; receive a velocity signal indicative of a velocity; and based on the displacement signal and the velocity signal, produce an electrical power signal indicative of at least one of a torque applied to the shaft, or a power applied to the shaft.

### CROSS REFERENCE TO RELATED APPLICATION

This application claims the priority benefit of provisional application 61/949,370, filed Mar. 7, 2014, the entirety of which is incorporated by reference herein.

### TECHNICAL FIELD

This document relates to measurement systems.

### BACKGROUND

There is sometimes a need to measure the torque applied to a shaft, including (but not limited to) a shaft in a vehicle's drive train. Some techniques exist for doing so, such as those employing strain gauges, piezoelectric components, or the like.

Measuring the torque applied to certain drive train components of a human-powered vehicle is useful for determining the human's power output in riding the vehicle.

### SUMMARY

In general, in one aspect, a measurement system has measurement instrument having a first and second component. The first component is mechanically coupled to a first point on a shaft. The second component is mechanically coupled to a second point on the shaft. The measurement instrument is configured to generate an electrical displacement signal indicative of a displacement between the first and second components. A processor is in data communication with the measurement instrument, and the processor configured to: receive the displacement signal from the measurement instrument; receive a velocity signal indicative of a velocity; and based on the displacement signal and the velocity signal, produce an electrical power signal indicative of at least one of a torque applied to the shaft, or a power applied to the shaft.

Implementations may include one or more of the following features: The first component includes an electromagnetic sensor. The second component includes multi-pole magnetic tape. The first component includes an optical sensor. A distance between the first component and the second component is at most 25% of a length of the shaft; and a distance between the first point and the second point is at least 75% of the length of the shaft. A mechanical coupling of the first component includes a cantilever. The velocity is an angular velocity of a crank arm coupled to the shaft. The velocity is a linear velocity of a vehicle using a drive train containing the shaft. The measurement instrument further includes a third component mechanically coupled to a third point on the shaft, in which the measurement instrument is further configured to generate a supplemental electrical signal indicative of a displacement between the first and third components; and the processor is further configured to: receive the supplemental signal; and produce the power signal based on the displacement signal, the velocity signal, and the supplemental signal. The processor is further configured to: accept calibration input from a user, the calibration input relating to physical parameters of a vehicle using the drive train; and adjust a mathematical formula used to compute power based on the calibration input. The calibration input includes: a weight of the vehicle, and a displacement measurement at a time when known loads are applied to different ends of the shaft.

In general, in another aspect: measuring a displacement between a first component mechanically coupled to a first point on a shaft and a second component mechanically coupled to a second point on the shaft; identifying a mathematical torque/displacement model; and using the model, identifying a torque applied to the shaft.

Implementations may include one or more of the following features. The shaft is included in a drive train of a vehicle, and: identifying a velocity of the vehicle; and using the identified torque and the identified velocity, identifying a power applied to the shaft. Also including coupling the first component to the first point and coupling the second component to the second point, such that a distance between the first component and the second component is at most 25% of a length of the shaft, and a distance between the first point and the second point is at least 75% of the length of the shaft. Coupling either the first component or the second component to the shaft includes using a cantilever. Identifying the torque/displacement mathematical model includes receiving calibration data. The shaft is included in a drive train of a vehicle, the method further comprising prompting a user to apply a known torque to the shaft, thereby producing at least part of the calibration data. Prompting the user to apply a known torque to the shaft includes: identifying a weight of the vehicle; and prompting the user to lift the vehicle in a specified state so as to induce the known torque on the shaft. Also detecting the occurrence of the specified state using inertial instruments, and obtaining the calibration data upon the occurrence of the specified state. Also: using inertial instruments, detecting a vehicle state other than the specified state; and prompting the user to adjust the vehicle state towards the specified state.

Other aspects include other combinations of the features recited above and other features, expressed as methods, apparatus, systems, program products, and in other ways. Other features and advantages will be apparent from the description and from the claims.

### DESCRIPTION OF DRAWINGS

Embodiments of the invention described herein may be understood by reference to the following figures, which are provided by way of example and not of limitation:

FIG. 1 is a schematic depiction of a shaft experiencing torques.

FIGS. 2-4 are schematic depiction of measurement systems mounted on a shaft.

FIGS. 5A-C are a cross-sectional view of a measurement system mounted on a shaft experiencing bending.

FIG. 6-7 are schematic depictions of portions of a bicycle drive train.

FIG. 8 is a block diagram of a measurement system.

FIG. 9 is a flowchart for developing a displacement/torque model in the context of a pedal-powered vehicle.

FIG. 10 is a flowchart for computing torque and power applied to a shaft outfitted with a measurement system.

FIG. 11 is a schematic depiction of a measurement system mounted on a shaft.

Like references numbers refer to like structures.

### DETAILED DESCRIPTION

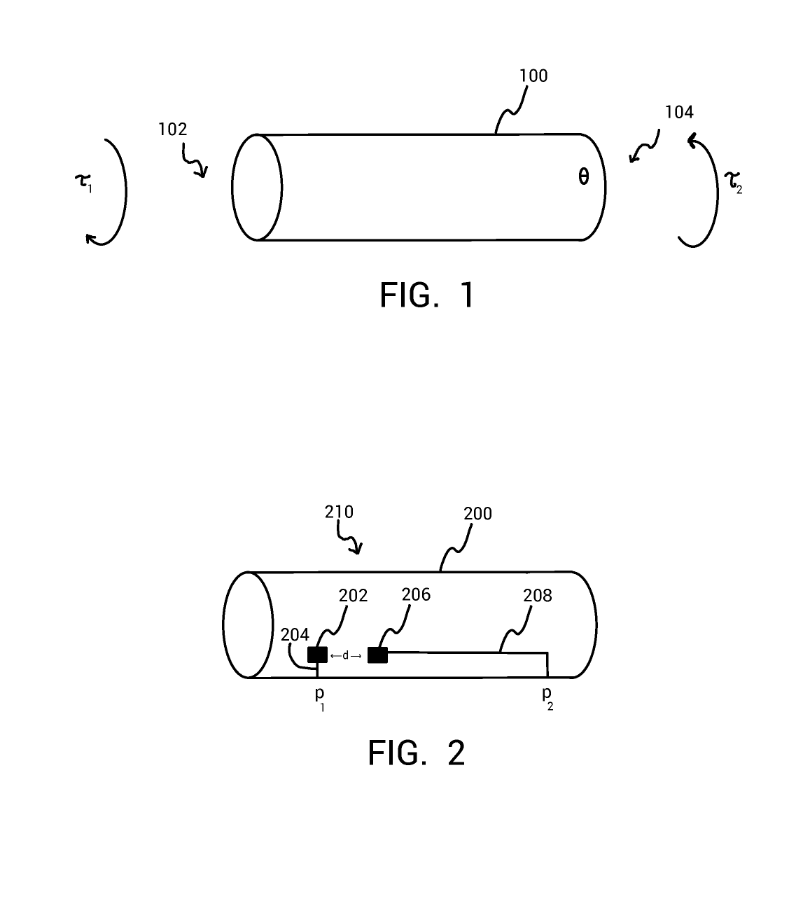

FIG. 1 is a schematic depiction of a shaft experiencing torques in opposite directions. The shaft 100 experiences the torque τ₁ at the end 102 and torque τ₂ at end 104, in the directions shown. In turn, the torques cause the respective ends 102, 104 to experience torsion (i.e., twist), thereby causing the end 102 to rotate by an angle θ relative to the other end 104. More generally, the angle θ of deformation occurs in the presence of a net torque τ on the shaft, whether such net torque is the result of a combination of individual torques or the result of a single torque.

Depending on the material composition and shape of the shaft 100 and the magnitude of the net torque τ, there is often a predictable relationship between the net torque τ and the angle θ of deformation. Techniques for identifying such relationships are described in more detail below. Among such relationships, for example, the net torque τ is often well-approximated as being directly proportional to θ, although other models are possible. Within the context of such a model, one may therefore determine the net torque τ from measuring the angle θ.

FIG. 2 is a schematic depiction of a measurement system mounted on a shaft. Among other things, the measurement system 210 is capable of identifying a net torque τ applied to a shaft on which the measurement system is deployed.

The measurement system 210 includes a first component 202 mounted via a first mechanical coupling 204 to a first point p₁ on the shaft 200, and second component 206 mounted via a second mechanical coupling 208 to a second point p₂ on the shaft. The first and second components are configured to collectively sense a displacement d between them, and may therefore be collectively thought of as a measurement instrument 209. This measurement instrument 209 is configured to output an electromagnetic signal indicating this displacement, referred to herein as a displacement signal. To that end, the measurement instrument 209 may include other such hardware, such as an antenna, to send the displacement signal to other components of the measurement system 210. For example, the displacement signal is received (perhaps indirectly through other electronic components) by a processor, operable to compute other quantities based on displacement between the components 202, 206 as described in more detail below.

In some implementations the first and second components 202, 206 can include electromagnetic components of various forms (e.g., magnets; Hall Effect sensors; anisotropic magnetoresistance (“AMR”) sensors; giant magnetoresistance (“GMR”) sensors; tunneling magnetoresistance (“TMR”) sensors; induction sensors; capacitance sensors; electrically conductive targets; optical sources, reflectors, and/or sensors; radio frequency emitters/receivers, etc.

In some implementations, there is a trade-off involved in the choice of components 202, 206, their relative positions, and the respective points p₁, p₂ on the shaft 200 to which they are coupled. In particular, many components such as those described above have a relatively short range (at least at peak accuracy) compared to the length of the shaft 200. However, the torsion angle θ is often very low (e.g., close to zero) between two points p₁, p₂ when the points are relatively close. In turn, this requires the components 202, 206 to have extremely high accuracy in order to accurately determine the angle θ, which can be expensive or otherwise infeasible.

One way to mitigate this trade-off is to rigidly couple the components to points p₁ and p₂ on the shaft 200 that are relatively far apart from each other, using couplings 204, 208 that bring the components 202, 206 relatively close together. For example, FIG. 2 illustrates a coupling 208 that includes a cantilever extending substantially the length of the shaft 200. Although not illustrated, coupling 204 may also include a cantilevered member or other projection bringing the component 202 closer to component 206. Advantageously, this allows a relatively small component displacement d to correspond to torsion angles θ between points p₁ and p₂ on the shaft that are separated substantially larger distances. In some implementations, the shaft 200 is hollow. Thus, the couplings 204, 208 can be deployed in the shaft's interior. In some implementations, the shaft 200 is not hollow. Thus, the couplings 204, 208 are deployed along the exterior of the shaft.

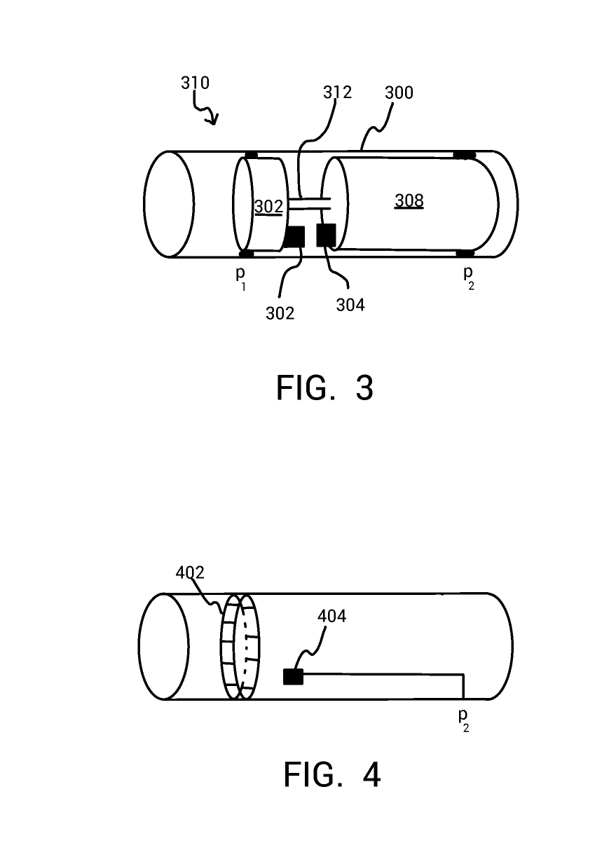

Other implementations are possible. For example, FIG. 3 shows a schematic illustration of a measurement system 310 mounted inside of a hollow shaft 300. The measurement system 310 includes a first component 302 coupled to a first point p₁ on the shaft via a first coupling 304, and a second component 306 coupled to a second point p₂ on the shaft via a second coupling 308. In some implementations, the first coupling 304 and second coupling 308 are rotatably coupled to each other by a member 312. In some implementations, member 312 has a relatively low stiffness, thereby allowing the couplings 304, 308 to independently rotate relatively easily.

In still another example, the first component can include multi-pole magnetic tape, as shown in FIG. 4. The multi-pole magnetic tape 402 is disposed circumferentially around a portion of the shaft 400. The displacement of the component 404 from the nearest pole can therefore be measured.

In some implementations, the distance between the first and second components is at most 1 centimeter, and the distance between the points to which they are coupled is at least 2 centimeters. In some implementations, the distance between the points to which the first and second components are coupled is at least twice the maximum operable sensing range of the first and second components. In some implementations, the distance between the first and second components is at most 25% of the shaft length, and the distance between the points to which they are coupled is at least 75% of the shaft length.

Each of the above measurement systems is operable to measure the torque applied to a shaft, which may appear in any setting. In some implementations, such a measurement system is deployed on a shaft in the drive train of a vehicle, such as human-powered vehicle (e.g., a bicycle) or other vehicle. For example, such a measurement system can be deployed on a crank arm spindle or rear axle of many types of bicycles. In the context of a vehicular application, measuring the torque on a shaft can be combined with other information to provide other useful performance metrics; in particular, the power exerted by a rider of a human-powered vehicle, as described further below.

Using the techniques described above has advantages over some other methods of directly measuring torque applied to the shaft. Some torque measurement techniques involve using strain gauges, piezoelectric components, or the like to directly measure torsion of the shaft. However, such components have the disadvantage of necessarily deforming during measurement, thereby leading to limited lifetime and/or increased cost. By contrast, the components described above do not deform during measurement, thereby leading to longer lifetime and/or reduced cost.

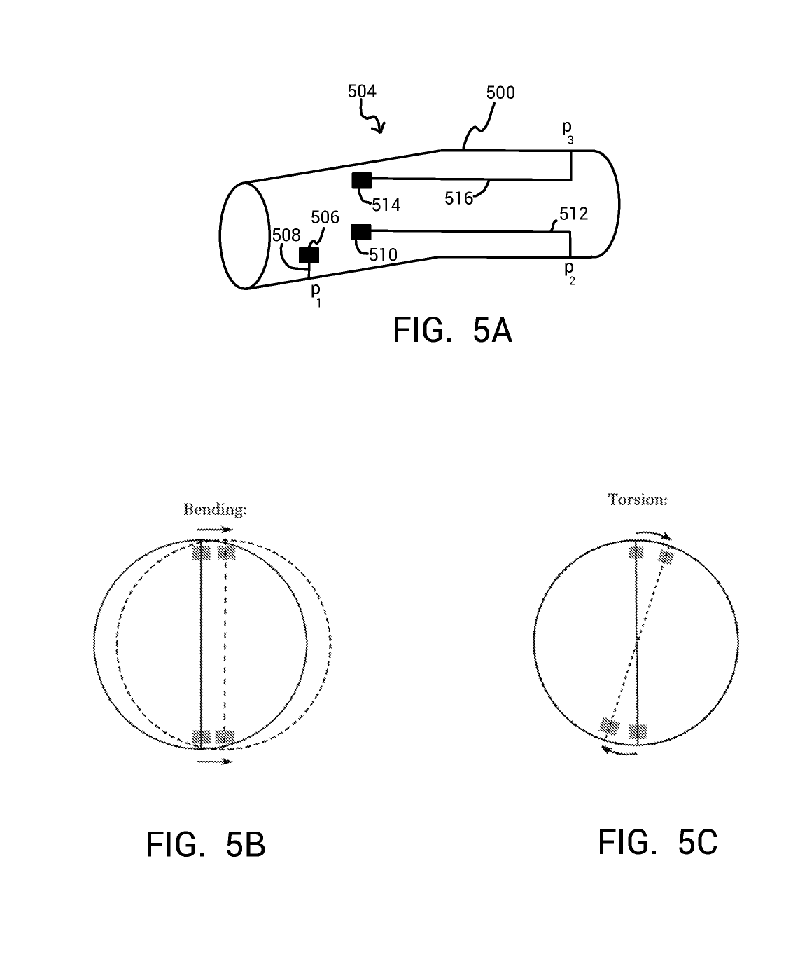

FIG. 5A is a cross-sectional view of a measurement system mounted on a shaft experiencing bending. When a shaft 500 experiences a torque having an axis different from the shaft axis 502, the shaft may experience bending in addition to (possibly) experiencing the torsion described above. In the context of measuring power applied to a shaft in the drive train of a human-powered vehicle, a measurement system that does not measure such bending may give inaccurate measurements of the applied power.

In some implementations, to account for the effects of bending, an extra component is included in the measuring device. That is, a measurement system 504 includes, as described above, a first component 506 mounted via a first mechanical coupling 508 to a first point p₁ on the shaft 500, and second component 510 mounted via a second mechanical coupling 512 to a second point p₂ on the shaft. The first and second components are configured to collectively sense a displacement d₁₂ between them. Additionally, the measurement system 504 also includes a third component 514 mounted via a third mechanical coupling 516 to a third point p₃ on the shaft 500. The first and third components are configured to collectively sense a displacement d₁₃ between them. In some implementations, the second and third points p₂ and p₃ are located on antipodal points of a circular cross-section of the shaft.

When the shaft bends, both distances d₁₂ and d₁₃ change in the same direction (i.e., both distances increase or both distances decrease). When points p₂ and p₃ are antipodal, the distances d₁₂ and d₁₃ change by the same amount. This is illustrated in FIG. 5B, which is a cross-sectional view of the shaft 500. Alternatively, when the shaft experiences torsion, the distances d₁₂ and d₁₃ change in the opposite directions (i.e., one distance increases, one distance decreases). Moreover, when points p₂ and p₃ are antipodal, the distances d₁₂ and d₁₃ change (in their respective directions) by the same magnitude. This is illustrated in FIG. 5C, which is a cross-sectional view of the shaft 500.

Thus, when points p₂ and p₃ are antipodal, a bending-corrected change in displacement d can be obtained as d=1/2|d₁₂−d₁₃|. That is, d changes only when the shaft experiences torsion, but not when the shaft experiences bending.

When points p₂ and p₃ are not antipodal, the distances d₁₂ and d₁₃ change by different amounts, but such amounts are related in a manner dependent on the geometric relationship between points p₁, p₂, and p₃, and the relative locations of the first, second and third components. From this geometric relationship, one of ordinary skill in the art can find an appropriate mathematical combination of signals d₁₂ and d₁₃ to produce a bending-corrected indication of torsion.

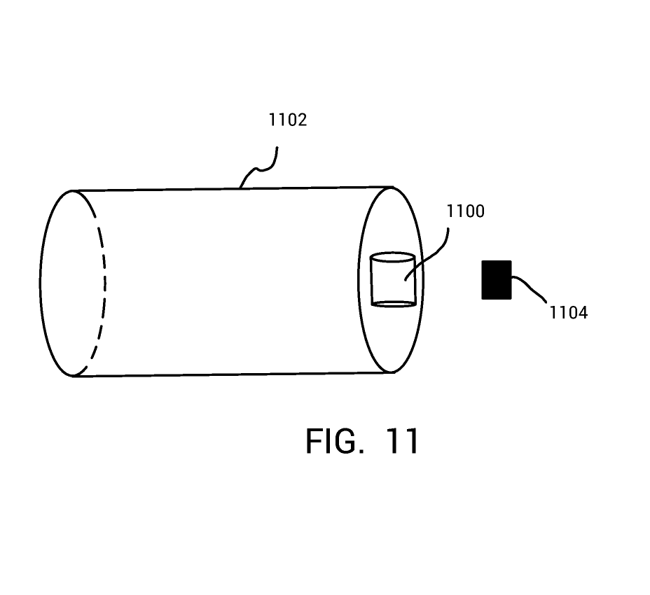

FIG. 11 shows another embodiment of a bending-independent measurement system. The measurement system includes a dipole magnet 1100 mounted at a known orientation with respect to a shaft 1102, and a planar sensor 1104 positioned to detect the dipole's magnetic field. In some implementations, the planar sensor 1104 includes an integrated circuit marketed by HONEYWELL™ under the serial number AN211, which is an AMR sensor. The sensor 1104 is mounted such that sensing plane of the sensor is perpendicular to the axis of the shaft. In this configuration, motion of the magnet due to bending is not sensed by the sensor 1104, whereas rotation of the magnet due to torsion is detectable.

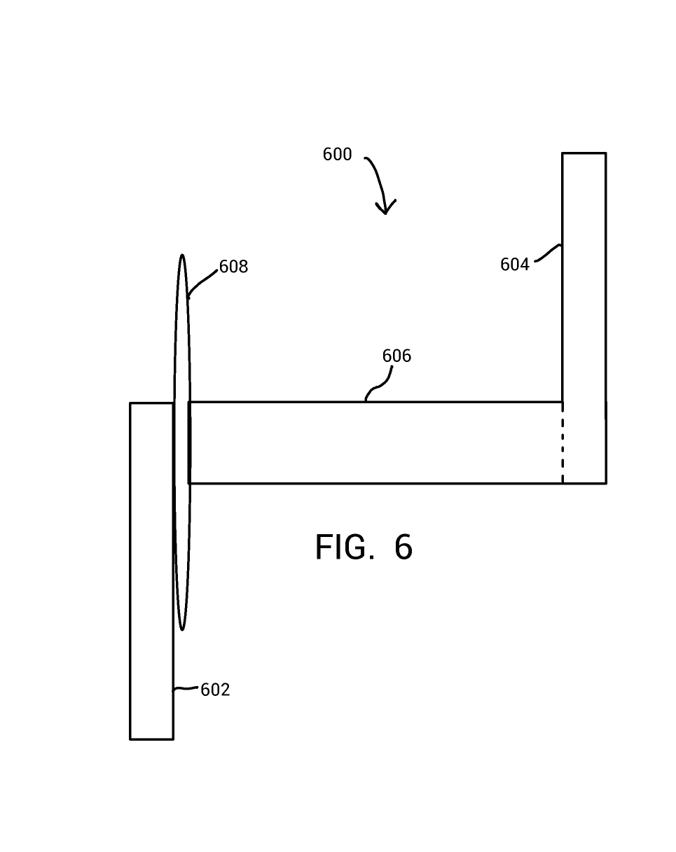

FIG. 6 is a schematic depiction of a portion of bicycle drive train. The drive train 600 includes a drive crank arm 602, a non-drive crank arm 604, a spindle 606, and a chain ring 608. When a force is applied to the non-drive crank arm 604, the spindle 606 experiences torsion as described above. The power P produced by the rider at a particular moment is given by the formula P=τ*ω, where τ is the torque applied to the spindle, and ω is the angular velocity of the spindle. A measurement system as described above can be used to measure τ, whereas traditional instrument can be used to measure ω. (Among such traditional measurement systems: inertial instruments, optical sensors, and/or magnetic sensors can be coupled to the spindle and/or crank arm. Additionally or alternatively, any technique can be used to measure the vehicle's linear speed, which in turn can be converted to a corresponding angular velocity ω using a mathematical model that incorporates pertinent dimensions of the vehicle's drivetrain components.)

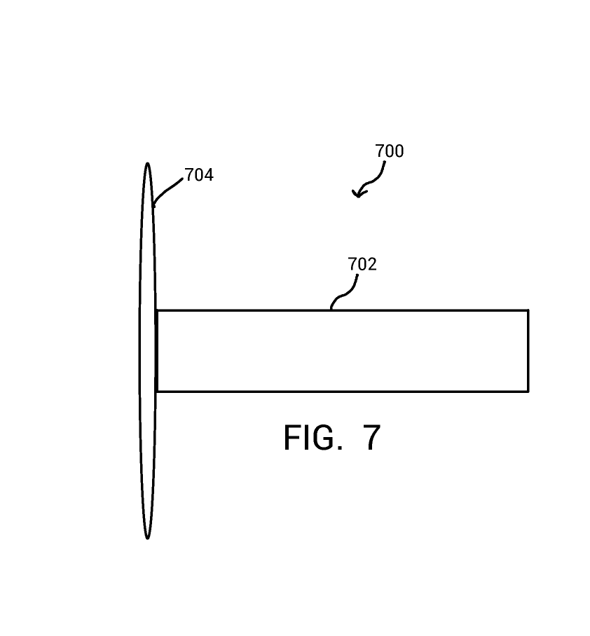

FIG. 7 is a schematic depiction of a portion of a bicycle drive train. The drive train 700 includes a rear wheel hub and a rear chain ring. Similarly to the previous paragraph, the rear chain ring applies a torque τ to the rear wheel hub. Measurement of this torque can be used, together with a measurement of the rear hub's angular velocity, to measure the power applied to the drive train at a particular moment.

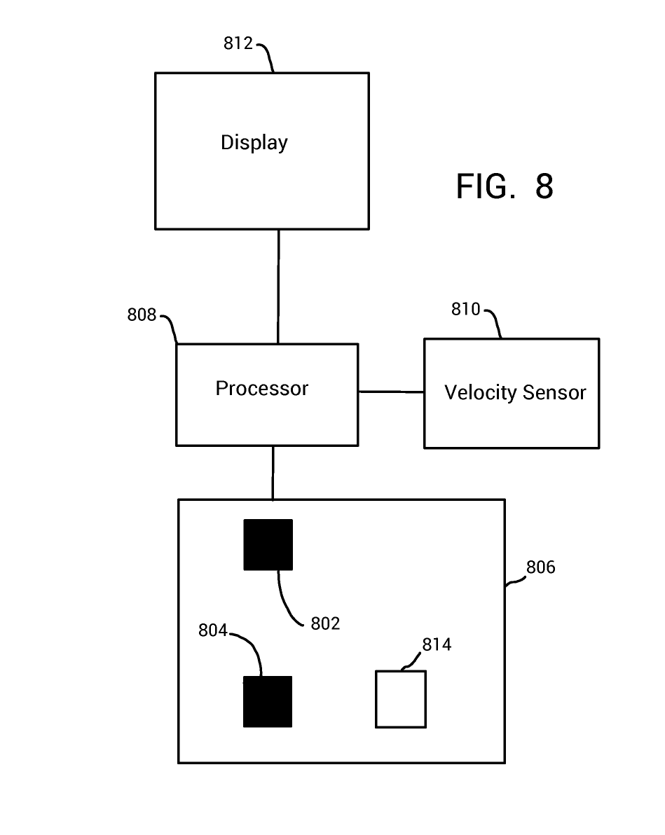

FIG. 8 is a block diagram of a measurement system. The measurement system 800 is suitable for deployment on a shaft in a vehicle's drive train, such as a human-powered vehicle. The measurement system 800 includes a first component 802 and a second component 804 that are collectively configured to sense a displacement between them and produce an electromagnetic displacement signal indicating this displacement, as described above. The components 802, 804 may be collectively regarded as a measurement instrument 806. The measurement instrument is in data communication with a processor 808. The data communication may be direct, or indirect through other electronic components (such as a signal processing components, including amplifiers, filters, analogue-to-digital converters, combinations thereof, etc.)

The measurement system also includes a velocity sensor 810 configured to sense a velocity of the vehicle and output an electromagnetic signal indicative thereof, referred to herein as a velocity signal. The velocity signal carries information to identify an angular velocity of a shaft, possibly after being input to a pre-determined mathematical model, as described above.

The processor 808 is operable to make calculations based on pre-determined mathematical models, examples of which are described in more detail herein. Among the results of such calculations include producing an electromagnetic signal indicative of the power a rider of the vehicle is applying to the shaft at a particular moment, referred to herein as a power signal.

The processor 808 is in data communication with a display 812, which is operable to display information to a user (e.g., the rider of the vehicle). Such information can include, but need not be limited to, the rider's power output, the torque measured on by the measurement system, or other quantities computed therefrom. In some implementations, the display may be included in external hardware, such as a mobile device (e.g., smartphone, smartwatch, etc.) of the user or a vehicle-mounted onboard computer. In some implementations, some processor functions (including calculations described above) are offloaded to one or more external processors, such as those found in such mobile devices or onboard computers.

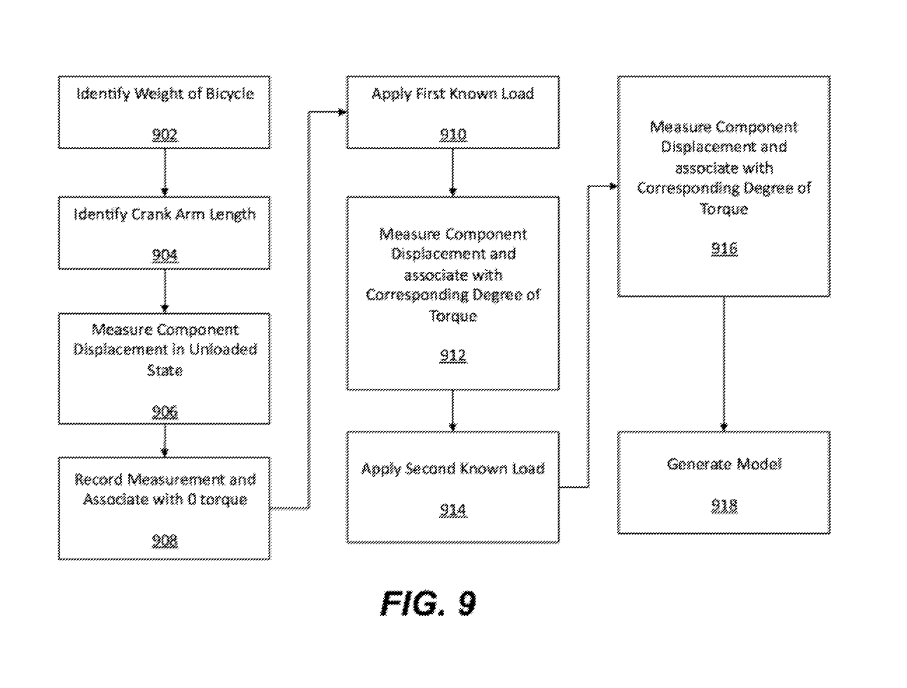

In some implementations, the measurement system 800 includes inertial instruments 814 that are operable to identify the position and/or orientation of the vehicle components to which the inertial instruments are coupled. As described below with respect to FIG. 9, these inertial instruments 814 may be useful in determining a displacement/torque model for a particular vehicle.

FIG. 9 is a flowchart for developing a displacement/torque model in the context of a pedal-powered vehicle. The method 900 is applicable to contexts in which the measurement system described above is deployed on a shaft in the drive train of a human-powered vehicle, such as a bicycle. Although the method 900 is discussed in this context, those of skill in the art will appreciate the applicability of the method 900 to other vehicles.

In some implementations, a user is guided through the steps of the method by an automated process executing on, e.g., a mobile device such as a smartphone or smartwatch.

Method 900 begins by identifying a weight of the bicycle (step 902). In some implementations, this involves the automated process prompting a user to weigh the bicycle using a suitable scale (or otherwise estimating/determining its weight), and receiving the user-supplied result as input. In step 904, the crank arm length is identified. In some implementations, step 904 includes presenting the user with a diagram, indicating where on a typical crank arm the length is written or, alternatively, a diagram indicating which component to measure. The automated process then accepts this user-supplied result as input.

In step 906, a measurement of the displacement measured by the measurement system is made when no load is applied to either crank arm. In some implementations, the automated process prompts the user to put the bicycle in such a state (e.g., rest the bicycle upside-down, with its wheels in the air and its seat and handlebars resting on the ground), and indicate to the process when that condition is achieved. The displacement measured by the measurement system is then recorded (step 908) and associated with zero torque.

In step 910, an equal load of known magnitude is applied to each crank arm, resulting in equal but opposing torques. In some implementations, the user is prompted to lift the bicycle by its pedals, ensuring the crank arms are parallel to the ground, thereby using the weight of the bicycle to generate the required torques. In particular, the magnitude of the torque transferred to the spindle by each crank arm is equal to half the weight of the bicycle times the crank arm length, each quantity being known from previous steps.

In some implementations, the user indicates to the automated process when this condition is achieved. In some implementations, the automated process detects this condition using output from inertial instruments coupled to the crank arms. In some implementations, based on output from such inertial instruments, the automated process provides feedback (e.g., an instruction to raise or lower a crank arm) to the user to help achieve the desired condition.

When the condition is achieved, the displacement measured by the measurement system is recorded and associated with the corresponding degree of torque (step 912).

The user is then instructed to again apply an equal load to each crank arm, but in the opposite direction as in step 910, thereby producing opposite torques on each crank arm (step 914). In some implementations, the automated process instructs the user to rotate the pedals 180 degrees and again lift the bicycle with the pedals parallel to the ground. When this condition is achieved, the displacement measured by measurement system is again recorded and associated with the known torque (step 916).

After performing steps 902-916, three data points are obtained, in which known torques are associated with measured displacements. In step 918, a mathematical model is generated using these data points using known data analysis techniques. For example, these three data points can be fit to a line (using, e.g., any variation of linear regression), a quadratic polynomial (using, e.g., Lagrange or Newtonian interpolation), or some other desired curve. This resultant model is stored (step 920) and used in subsequent torque and/or power calculations based on measured displacements.

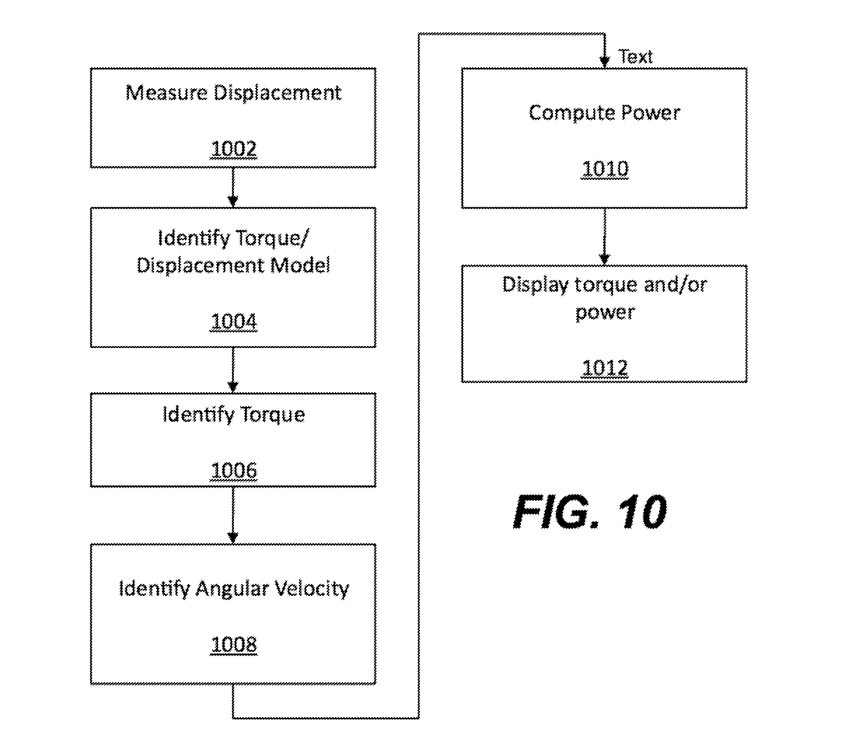

FIG. 10 is a flowchart for computing torque and power applied to a shaft outfitted with a measurement system. The method 1000 is described in the context of a bicycle, but those of skill in the art will appreciate its applicability to other vehicles. In step 1002, a displacement is measured between first and second components of a measurement system deployed on a drive train of the bicycle, as described above. A displacement/torque model is identified (step 1004) from which a torque t corresponding to the measured displacement is determined (step 1006). In step 1008, an angular velocity w of the shaft is identified. In step 1010, power P is computed from the formula P=τ*ω. At least one of the power P or the torque t is displayed to the user (step 1012).

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the invention(s) described herein are intended to include any suitable method of causing one or more other parties or entities to perform the steps consistent with the patentability of the following claims, unless a different meaning is expressly provided or otherwise clear from the context. Such parties or entities need not be under the direction or control of any other party or entity, and need not be located within a particular jurisdiction. Thus for example, a description or recitation of “adding a first number to a second number” includes causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed.

While the invention has been disclosed in connection with certain embodiments, other embodiments are possible and will be recognized by those of ordinary skill in the art. All such variations, modifications, and substitutions are intended to fall within the scope of this disclosure. Thus, the invention is to be understood with reference to the following claims.

What is claimed is:

1. A system comprising:
a measurement instrument having a first and second component, in which:
the first component is mechanically coupled to a first point on a shaft,
the second component is mechanically coupled to a second point on the shaft; and
the measurement instrument is configured to generate an electrical displacement signal indicative of a displacement between the first and second components;
a processor in data communication with the measurement instrument, the processor configured to:
receive the displacement signal from the measurement instrument;
receive a velocity signal indicative of a velocity;
based on the displacement signal and the velocity signal, produce an electrical power signal indicative of at least one of a torque applied to the shaft, or a power applied to the shaft.

2. The system of claim 1, wherein the first component includes an electromagnetic sensor.

3. The system of claim 2, wherein the second component includes multi-pole magnetic tape.

4. The system of claim 1, wherein the first component includes an optical sensor.

5. The system of claim 1, wherein:
a distance between the first component and the second component is at most 25% of a length of the shaft; and
a distance between the first point and the second point is at least 75% of the length of the shaft.

6. The system of claim 1, wherein a mechanical coupling of the first component includes a cantilever.

7. The system of claim 1, wherein the velocity is an angular velocity of a crank arm coupled to the shaft.

8. The system of claim 1, wherein the velocity is a linear velocity of a vehicle using a drive train containing the shaft.

9. The system of claim 1, wherein the measurement instrument further includes a third component mechanically coupled to a third point on the shaft, and wherein:
the measurement instrument is further configured to generate a supplemental electrical signal indicative of a displacement between the first and third components; and
the processor is further configured to:
receive the supplemental signal; and
produce the power signal based on the displacement signal, the velocity signal, and the supplemental signal.

10. The system of claim 1, wherein the processor is further configured to:
accept calibration input from a user, the calibration input relating to physical parameters of a vehicle using the drive train; and
adjust a mathematical formula used to compute power based on the calibration input.

11. The system of claim 10, in which the calibration input includes: a weight of the vehicle, and a displacement measurement at a time when known loads are applied to different ends of the shaft.

12. A method comprising:
measuring a displacement between a first component mechanically coupled to a first point on a shaft and a second component mechanically coupled to a second point on the shaft using a cantilever;
identifying a mathematical torque/displacement model; and
using the model, identifying a torque applied to the shaft.

13. The method of claim 12, in which the shaft is included in a drive train of a vehicle, the method further comprising:
identifying a velocity of the vehicle;
using the identified torque and the identified velocity, identifying a power applied to the shaft.

14. The method of claim 12, further comprising coupling the first component to the first point and coupling the second component to the second point, such that a distance between the first component and the second component is at most 25% of a length of the shaft, and a distance between the first point and the second point is at least 75% of the length of the shaft.

15. The method of claim 12, wherein the displacement between the first and second components is at most 2 centimeters, and wherein a displacement between the first and second points on the shaft is at least 4 centimeters.

16. The method of claim 12, wherein identifying the torque/displacement mathematical model includes receiving calibration data.

17. The method of claim 16, wherein the shaft is included in a drive train of a vehicle, the method further comprising prompting a user to apply a known torque to the shaft, thereby producing at least part of the calibration data.

18. The method of claim 17, wherein prompting the user to apply a known torque to the shaft includes:
identifying a weight of the vehicle; and
prompting the user to lift the vehicle in a specified state so as to induce the known torque on the shaft.

19. The method of claim 18, further comprising detecting the occurrence of the specified state using inertial instruments, and obtaining the calibration data upon the occurrence of the specified state.

20. The method of claim 18, further comprising:
using inertial instruments, detecting a vehicle state other than the specified state; and
prompting the user to adjust the vehicle state towards the specified state.
